(19) United States
(12) Patent Application Publication
(10) Pub. No.: US 2006/0041529 A1
(43) Pub. Date: Feb. 23, 2006

(54) Optical disk device

(75) Inventor: Shuhei Nakayama, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/133,327

(22) Filed: May 20, 2005

(30) Foreign Application Priority Data
May 21, 2004 (JP) P2004-152245

(51) Int. Cl. G06F 17/30; G06F 7/00

(52) U.S. Cl. 707/2

(57) ABSTRACT

For each of the contents recorded on an optical disk, user identification data that shows an administrator of the contents is added. The optical disk device acquires user identification data added to each of the contents recorded on the optical disk. The optical disk device accepts an input of user identification data and a password when reproducing the optical disk, and when these are correct, the contents added with the inputted user identification data are reproduced in order while skipping the contents that are not added with the inputted user identification data.

### BACKGROUND OF THE INVENTION

1. Field of the Invention

The present invention relates to an optical disk device which reproduces contents recorded on an optical disk such as a CD, DVD, or the like.

2. Description of the Related Art

Conventionally, optical disk devices for reproducing contents recorded on an optical disk such as a CD, DVD, or the like have generally spread. JP-A-2001-123557 discloses an optical disk device, wherein identification data indicating reproduction scenes can be added to each of the contents (music) recorded on an optical disk, and according to a reproduction scene selected by a user, contents that are not added with corresponding identification data are skipped, and contents added with the corresponding identification data are reproduced in order. In this optical disk device of JP-A-2001-123557, an operation for program reproduction for reproducing the contents according to a selected reproduction scene in order can be performed by only selecting the reproduction scene, so that operability for a user is improved.

### SUMMARY OF THE INVENTION

However, in a case where a plurality of users share an optical disk, by using the configuration disclosed in JP-A-2001-123557, it becomes possible for each user to reproduce only the contents recorded by himself/herself in order while skipping contents recorded by other users, however, the contents recorded by a user cannot be prevented from being viewed by other users. Concretely, the identification data in JP-A-2001-123557 is defined as identification data indicating the user who recorded the contents, and when reproducing, the identification data is inputted, the contents that are not added with the corresponding identification data are skipped, and the contents added with the corresponding identification data are reproduced, whereby each user can view the contents recorded by himself/herself in order while skipping the contents recorded by other users. However, if a user inputs another user's identification data, the user can also view the contents recorded by other users. For example, when a family shares an optical disk, a father, etc., cannot prevent his child from viewing the contents that the father does not want the child to view.

It is an object of the invention to provide an optical disk device which makes it possible for a user to reproduce only the contents recorded by himself/herself in order while skipping the contents recorded by other users, and prevents the contents recorded by himself/herself from being viewed by other users.

According to one aspect of the invention, the optical disk device has the following configuration for solving the above-described problems.

(1) An optical disk device including a reproduction means for reproducing contents recorded on an optical disk set in a main body, includes:

an administrator identification data acquiring means which acquires administrator identification data for identifying an administrator added to the contents for each of the contents recorded on the optical disk;

a password acquiring means which acquires passwords associated with the administrator identification data, wherein

the reproduction means has an administrator specifying reproduction function which acquires administrator identification data for each of the contents recorded on the optical disk set in the main body by the administrator identification data acquiring means, accepts an input of the administrator identification data and the password when starting reproducing the optical disk, and reproduces the contents added with the inputted administrator identification data in order by skipping the contents that are not added with the inputted administrator identification data, and the device further comprises:

a reproduction prohibiting means which prohibits the reproduction means from reproducing the contents when the password associated with the administrator identification data added to the contents to be reproduced is not inputted.

With this configuration, administrator identification data indicating an administrator of contents is added to each of the contents recorded on an optical disk. The administrator identification data acquiring means acquires administrator identification data added to each of the contents recorded on the optical disk. The password acquiring means acquires a password associated with the administrator identification data. The reproduction means accepts an input of administrator identification data and a password when reproducing the optical disk, and when these are correct, the contents added with the inputted administrator identification data are reproduced in order while skipping the contents that are not added with the inputted administrator identification data. On the other hand, when the inputted password is not correct, the reproduction prohibiting means prohibits the reproduction means from reproducing the contents.

Therefore, when a plurality of users share an optical disk, it is possible for a user to reproduce and view the contents recorded by himself/herself in order while skipping the contents recorded by other users, and the contents recorded by the user can be prevented from being viewed by other users.

(2) A storage means which stores the administrator identification data and the passwords by associating these with each other is provided, and the password acquiring means acquires a password associated with administrator identification data added to the contents to be reproduced by the reproduction means from the storage means.

With this configuration, the storage means stores the administrator identification data and the passwords by associating these with each other, and the password acquiring means acquires a password associated with inputted administrator identification data from this storage means.

(3) A recording means is provided which records the administrator identification data for identifying an administrator of contents on an optical disk when recording the contents on the optical disk.

With this configuration, the recording means records administrator identification data for identifying an administrator of contents on an optical disk when recording the contents on the optical disk. Therefore, it is not necessary to provide the device main body with the configuration for storing administrator identification data for identifying an administrator for each of the contents recorded on the optical disk, and this prevents the cost of the device main body from increasing.

The administrator identification data according to each of the contents is recorded on, for example, the TOC region of an optical disk.

According to one aspect of the invention, when a plurality of users share an optical disk, a user can reproduce and view the contents recorded by himself/herself in order while skipping the contents recorded by other users, and the contents recorded by the user can be prevented from being viewed by other users.

### BRIEF DESCRIPTION OF THE DRAWINGS

FIG. 1 is a block diagram showing the configuration of the main part of the optical disk device of the embodiment of the invention;

FIG. 2 is an explanatory view of data stored in the memory of the optical disk device of the embodiment of the invention;

FIG. 3 is a flowchart showing the password registration processing;

FIG. 4 is a flowchart showing contents recording processing; and

FIG. 5 is a flowchart showing processing of reproduction from the optical disk.

### DESCRIPTION OF THE PREFERRED EMBODIMENTS

Hereinafter, an optical disk device of an embodiment of the invention is described.

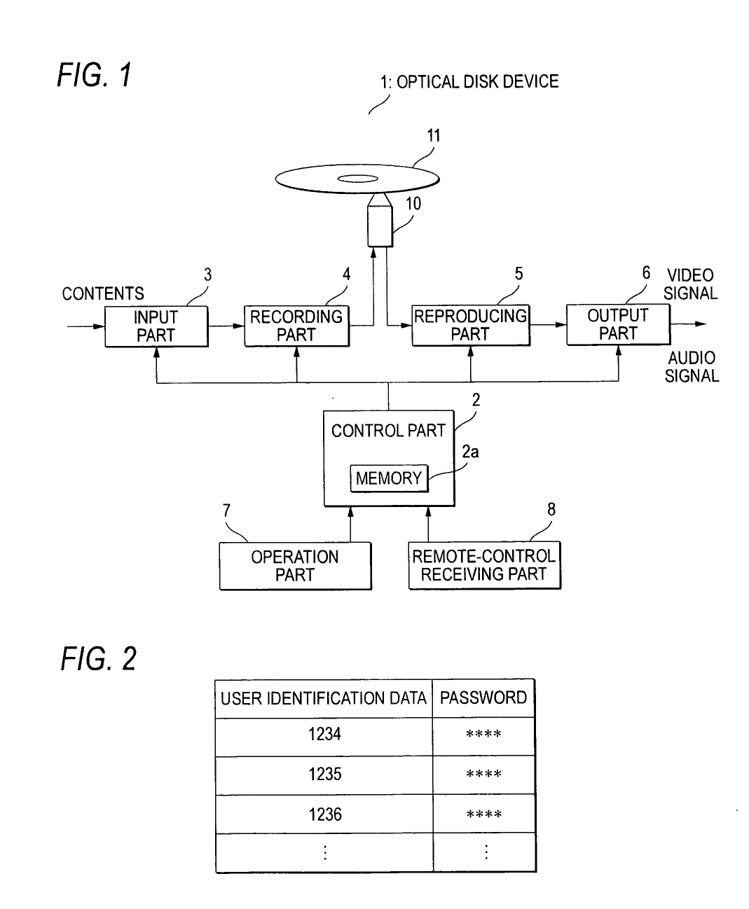

FIG. 1 is a block diagram showing the configuration of the main part of an optical disk device of an embodiment of the invention. The optical disk device 1 of an embodiment of the invention includes a control part 2 for controlling operations of the main body, an input part 3 for accepting an input of contents, a recording part 4 for recording the contents inputted to the input part 3 on an optical disk 11 such as a CD or DVD, etc., set in the main body, a reproducing part 5 which reads data of the contents recorded on the optical disk 11 set in the main body and generates video signals and audio signals of the contents, an output part 6 for outputting video signals and audio signals of the contents generated by the reproducing part 5, an operation part 7 on which keys for input operations to the main body are arranged, and a remote-control receiving part 8 for receiving a control signal for the main body transmitted from a remote controller that is not shown. The control part 2 is provided with, as shown in FIG. 2, a memory 2a that stores user identification data for identifying a user who uses the device main body (corresponding to the administrator identification data mentioned in the embodiment of the invention) and a password of this user by corresponding these to each other. This memory 2a is a nonvolatile memory such as an EEPROM.

The input part 3 has a tuner function for extracting and outputting programs (contents) broadcasted on a selected channel from television broadcasting signals received by an antenna that is not shown, and an external input function for accepting an input of contents from an external device connected to the main body. The recording part 4 controls a laser beam to be irradiated onto the optical disk 11 from a pickup head 10 and records the contents on the optical disk 11. The reproducing part 5 generates video signals and audio signals of the contents based on RF signals outputted from the pickup head 10. To the output part 6, a display device and a speaker, etc., not shown, are connected. The input operation to the main body is performed by the operation part 7 or a remote controller that is not shown.

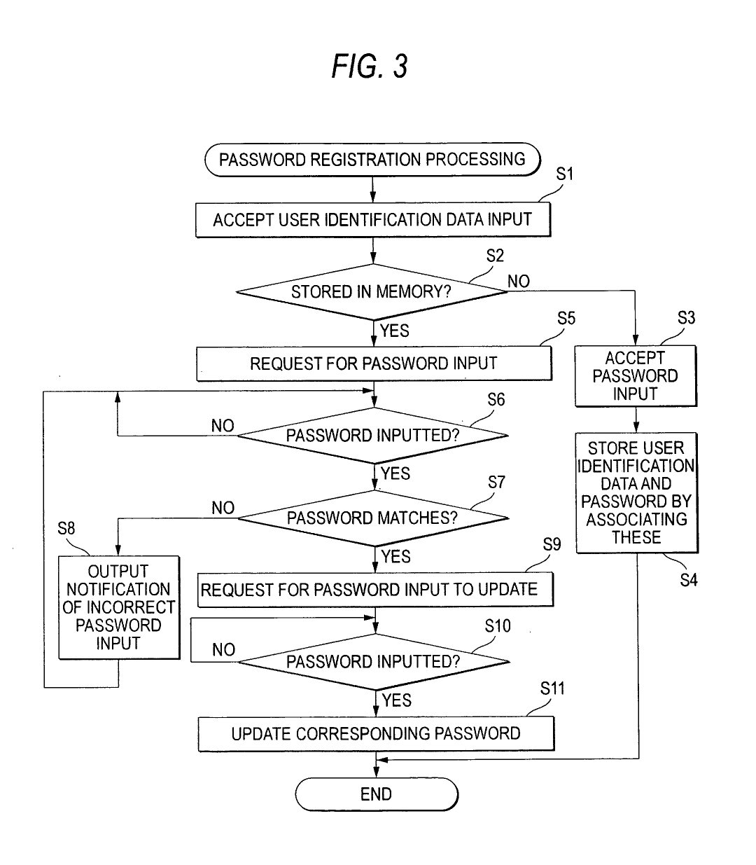

Next, operations of the optical disk device 1 of an embodiment of the invention are described. First, password registration processing for registering user identification data and passwords in the memory 2a is described. FIG. 3 is a flowchart showing this password registration processing. A user changes the device main body into a password registration mode by operating the operation part 7 or a remote controller that is not shown. The optical disk device 1 accepts an input of the user identification data first (s1) . At this point, the user inputs his/her own user identification data by operating the operation part 7 or the remote controller that is not shown. The optical disk device 1 judges whether the user identification data inputted in s1 has been stored in the memory 2a (s2), and when it is not stored, processing of new registration is performed, and when it is stored, processing of password updating is performed.

The optical disk device 1 accepts an input of a password when the user identification data inputted in s1 is not stored in the memory 2a (s3) . The optical disk device 1 stores the user identification data accepted in s1 and the password accepted in s3 in the memory 2a by associating these with each other (s4), and then ends this processing. On the other hand, in the case where the user identification data inputted in s1 has been stored in the memory 2a, the optical disk device 1 requests an input of a password stored in the memory 2a (s5), and awaits an input of the password (s6). Herein, a user inputs the password that is stored in the memory 2a before being updated to the device main body. The optical disk device 1 outputs a notification that the inputted password is wrong when the inputted password does not match the password stored in the memory 2a (s7, s8), and returns to s6 and awaits re-inputting of a password. To the contrary, when the inputted password matches the password stored in the memory 2a, an input of an updating password is requested (s7, s9) . When the updating password is inputted (s10), the optical disk device 1 updates the password that has been stored in the memory 2a and associated with the corresponding user identification data (user identification data inputted in s1) to the password accepted in s10 (s11), and then ends this processing.

The optical disk device 1 outputs an OSD image indicating operation procedures for a user from the output part 6 for improvement in the user's operability in this password registration processing. This OSD image has been recorded on a recording medium such as a hard disk that is not shown.

When the password stored in the memory 2a is updated, an input of the password stored in the memory 2a is required, so that a user cannot update another user's password without permission.

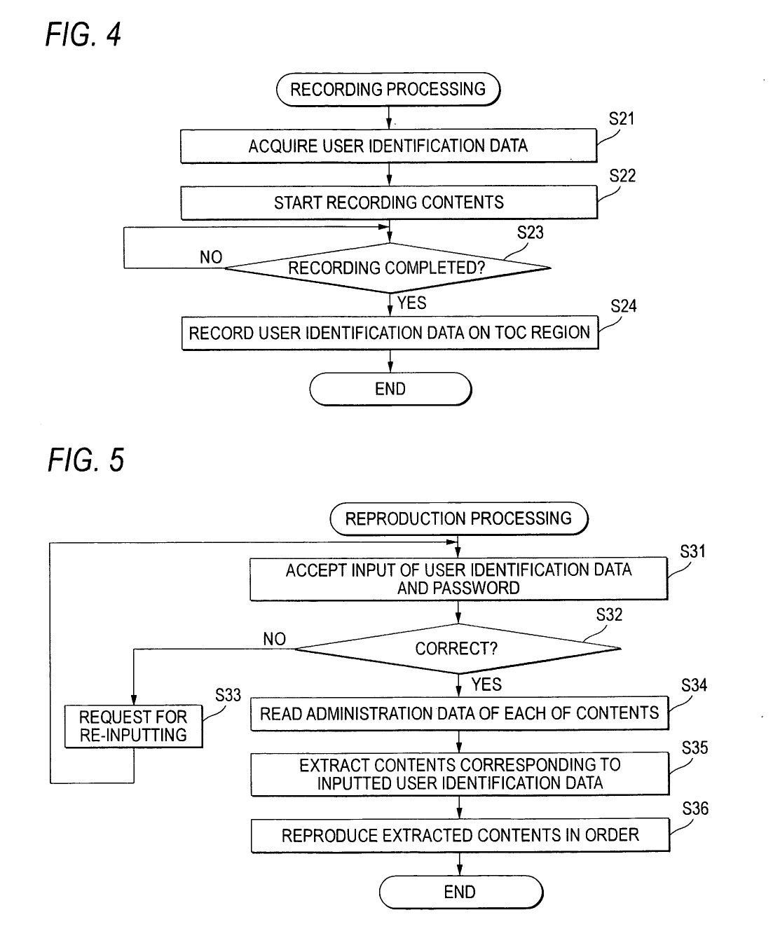

Next, operations of the optical disk device 1 when recording the contents are described. FIG. 4 is a flowchart showing the contents recording processing. The optical disk device 1 acquires user identification data of a user who records the contents before starting to record the contents (s21) . For example, when recording of the contents is copying of the contents inputted from an external device, before starting copying, the user is requested to input the user identification data. When recording of the contents is programmed recording, the user is requested to input the user identification data when the user programs recording, and when executing the programmed recording, the user identification data contained in the programmed recording data (data on the recording start time and a channel to be recorded, etc.) is acquired.

When the user identification data is acquired, the optical disk device 1 starts recording the contents on the optical disk 11 (s22). The recording part 4 encodes video signals and audio signals of the contents to be recorded, inputted from the input part 3, and controls the laser beam to be irradiated from the pickup head 10 onto the optical disk 11 based on the encoded data, whereby recording of the contents on the optical disk 11 is performed. When recording of the contents, started in s22, is completed (s23), the optical disk device 1 records administration data for administrating the contents on the TOC region of the optical disk 11 (s24). In this administration data, the user identification data acquired in s21 is contained. In other words, on the TOC region of the optical disk 11, for each of the contents recorded on this optical disk 11, user identification data for identifying a user who recorded the corresponding contents is recorded. Therefore, even when a plurality of users share the optical disk 11, for each of the contents recorded on the optical disk 11, the users who recorded the contents can be identified. For each of the contents recorded on the optical disk 11, data (user identification data) for identifying a user who has recorded is recorded on the optical disk 11 instead of being recorded on the device main body, so that it is not necessary to provide a configuration for storing data for identifying users who recorded contents, for each of the contents in the device main body, and the problem of a cost increase of the device main body does not result.

Next, operations of the optical disk device 1 when reproducing the contents recorded on the optical disk 11 are described. FIG. 4 is a flowchart showing the processing for reproduction from the optical disk. The optical disk device 1 accepts an input of user identification data and a password first (s31) . The optical disk device 1 judges whether or not the inputted user identification data and password are correct (s32). In s32, depending on whether or not the user identification data inputted at this time has been stored in the memory 2a, or in the case where the data has been stored, depending on whether or not a password associated with this user identification data and the password inputted at this time match each other, it is judged whether or not these are correct. In the case where the user identification data inputted at this time has not been stored in the memory 2a or the password inputted at this time does not match the password associated with the stored user identification data, they are judged as incorrect. When they are judged as incorrect in s32, the optical disk device 1 outputs a request for re-inputting of user identification data and a password (s33) and returns to s31.

When they are judged as correct in s32, the optical disk device 1 reads administration data of each of the contents recorded on the optical disk 11 set in the main body (s34). The administration data of each of the contents recorded on the optical disk 11 are recorded on the TOC region of this optical disk 11. As described above, the administration data contains user identification data for identifying a user who recorded the contents. The optical disk device 1 extracts all contents recorded by a user identified based on the user identification data inputted at this time (s35) . The optical disk device 1 skips contents that have not been extracted in s35, and starts processing to reproduce the contents extracted in s35 in order (s36). In reproduction of the contents, the reproducing part 5 decodes RF signals outputted from the pickup head 11 and generates video signals and audio signals based on the decoded RF signals, and the output part 6 outputs the video signals and audio signals generated at the reproducing part.

Thus, the optical disk device 1 of this embodiment can identify a user who recorded contents for each of the contents recorded on the optical disk 11. Since the user can view the contents recorded by himself/herself in order only by inputting user identification data and a password, even when the optical disk 11 is shared by a plurality of users, a user can easily reproduce and view only the contents recorded by himself/herself. Furthermore, unless a correct password is inputted, reproduction of the contents is prohibited, so that the contents recorded by a user himself/herself can be prevented from being viewed by other users without permission. Therefore, when a family shares an optical disk 11, a father, etc., can prevent his child from viewing the contents that the father does not want the child to view.
[FIG. 1]
1 Optical disk device
Contents
3 Input part
4 Recording part
5 Reproducing part
6 Output part
Video signals
Audio signals
2 Control part
2a Memory
7 Operation part
8 Remote-control receiving part
[FIG. 2]
User identification data
Password
[FIG. 3]
Password registration processing
s1 Accept user identification data input
s2 Stored in memory?
s3 Accept password input
s4 Store the user identification data and password by
associating these
s5 Request for password input
s6 Password inputted?
s7 Password matches?
s8 Output notification of incorrect password input
s9 Request for password input to update
s10 Password inputted?
s11 Update the corresponding password
[FIG. 4]
Recording processing
s21 Acquire the user identification data
s22 Start recording the contents
s23 Recording completed?
s24 Record the user identification data on the TOC region
[FIG. 5]
Reproduction processing
s31 Accept input of user identification data and password
s32 Correct?
s33 Request for re-inputting
s34 Read the administration data of each of the contents
s35 Extract the contents corresponding to the inputted user identification data
s36 Reproduce the extracted contents in order

What is claimed is:

1. An optical disk device comprising:
a reproduction means for reproducing contents recorded on an optical disk set in a main body;
an administrator identification data acquiring means which acquires administrator identification data for identifying an administrator added to the contents for each of the contents recorded on the optical disk;
a storage means which stores the administrator identification data and passwords by associating these with each other; and
a password acquiring means which acquires passwords associated with the administrator identification data added to the contents to be reproduced by the reproduction means, wherein the reproduction means has an administrator specifying reproduction function which acquires administrator identification data for each of the contents recorded on the optical disk set in the main body by the administrator identification data acquiring means,
wherein the reproduction means accepts an input of the administrator identification data and the password when starting reproducing the optical disk, and
wherein the reproduction means reproduces the contents added with the inputted administrator identification data in order by skipping the contents that are not added with the inputted administrator identification data, and
the optical disk device further includes:
a reproduction prohibiting means which prohibits the reproduction means from reproducing the contents when the password associated with the administrator identification data added to the contents to be reproduced is not inputted; and
a recording means which records the administrator identification data for identifying an administrator of contents on an optical disk when recording the contents on the optical disk.

2. An optical disk device comprising:
a reproduction means for reproducing contents recorded on an optical disk set in a main body;
an administrator identification data acquiring means which acquires administrator identification data for identifying an administrator for each of the contents recorded on the optical disk; and
a password acquiring means which acquires passwords associated with the administrator identification data, wherein
the reproduction means has an administrator specifying reproduction function which acquires administrator identification data for each of the contents recorded on the optical disk set in the main body by the administrator identification data acquiring means,
wherein the reproduction means accepts an input of the administrator identification data and the password when starting reproducing the optical disk, and
wherein the reproduction means reproduces the contents added with the inputted administrator identification data in order by skipping the contents that are not added with the inputted administrator identification data, and
the optical disk device further includes a reproduction prohibiting means which prohibits the reproduction means from reproducing the contents when the password associated with the administrator identification data added to the contents to be reproduced is not inputted.

3. The optical disk device according to claim 2, further comprising:
a storage means which stores the administrator identification data and the passwords by associating these with each other, wherein the password acquiring means acquires a password associated with administrator identification data added to the contents to be reproduced by the reproduction means from the storage means.

4. The optical disk device according to claim 2, further comprising:
a recording means which records the administrator identification data for identifying an administrator of contents on an optical disk when recording the contents on the optical disk.

5. The optical disk device according to claim 3, further comprising:
a recording means which records the administrator identification data for identifying an administrator of contents on an optical disk when recording the contents on the optical disk.
